(19) United States
(12) Patent Application Publication
(10) Pub. No.: US 2024/0025780 A1
(43) Pub. Date: Jan. 25, 2024

(54) METHOD FOR ELIMINATING THE USE OF CHEMICAL PRODUCTS IN PRE-TREATMENT IN SEAWATER DESALINATION PLANTS BASED ON REVERSE OSMOSIS

(71) Applicant: INGENIERÍA Y DESARROLLO DE SISTEMAS DE TRATAMIENTO DE AGUAS Y MEDIOAMBIENTE S. A., Las Palmas (ES)

(72) Inventor: Aldo Munoz Elguera, Las Palmas (ES)

(21) Appl. No.: 18/254,185

(22) PCT Filed: Dec. 28, 2020
(86) PCT No.: PCT/ES2020/070823

§ 371 Date: May 24, 2023

(51) Int. Cl. C02F 3/12; C02F 1/66; B01D 61/04

(52) U.S. Cl. CPC C02F 3/1268; C02F 1/66; B01D 61/04; C02F 2103/08

(57) ABSTRACT

Disclosed is a method for eliminating the use of chemical products in pre-treatment in seawater desalination plants based on reverse osmosis, by substituting physical treatment units formed by sand filters (6) with a pore size of 20 μm, filters (10) having a medium pore size of 10 μm and filters (13) having small pore size of 1-5 μm, and systems (7) for washing the sand filters, systems (11) for washing the medium-pore filters and systems (14) for washing the small-pore filters, by a single physical treatment unit formed by an MBR ultrafiltration membrane system (23), and for eliminating the dosing of chemical anti-scaling agents such as Na₆P₆O₁₈ (15) by dosing H₂SO₄ (25) to adjust the pH of the seawater between 6 and 6.5, to prevent salt precipitation on the reverse osmosis membranes (18).

### STATE OF THE ART

This patent application concerns a process for the elimination of the use of chemicals in the pre-treatment of reverse osmosis seawater desalination plants. Therefore, the field of technology in which the invention is included is the water treatment industry, specifically the reverse osmosis desalination sector.

### BACKGROUND TO THE INVENTION

To date, reverse osmosis seawater desalination plants generally consist of the following stages: seawater collection, chemical pre-treatment (dosing of H₂SO₄, NaClO, FeCl₃, MBS, and antifouling), physical pre-treatment by filtration in sand filters (20 micron porosity), spark plug filters (10 micron porosity) and spark plug filters (5 micron porosity or currently one micron porosity cartridge filters) and then on to the high pressure line, to the membrane racks where reverse osmosis takes place, with the brine flowing out of one side and into the sea, and the osmosed water that goes to the post-treatment system, and finally to distribution.

In desalination plants, it has been common practice to shock-dosage NaClO (50 ppm) into the seawater in the collection chamber for prior control of biological contamination, before it was pumped to the plant's pre-treatment line, where it received a second dosage of NaClO (50 ppm), as well as the other chemical dosages, carried out in excess, far from the optimal dosages.

Once the desalination plant has been built, the pre-treatment will have been sized for a nominal quality and flow of the water to be desalinated. Any increase in the feed flow would cause the physical and chemical pre-treatment processes not to function property, the membranes of the reverse osmosis unit would also not be affected, as the membranes would become fouled more quickly, requiring more frequent rinsing. The cost of washing includes a consumption of reagents, energy and previously produced desalinated water and a period of unproductivity. In addition, as the frequency of washes increases, the useful life of the membranes is shortened, forcing to replace them ahead of schedule. All this implies an increase in the cost of the water produced.

For reverse osmosis membranes to function properly, meeting the warranty requirements of the suppliers, require one or maximum two washes per year, which implies that the seawater that comes into contact with them must be of a specific quality, in particular with regard to their microbiological, particulate, dispersion and suspended particle content. The required quality of the seawater that is brought into contact with the reverse osmosis membranes can only be achieved with adequate pretreatment to adequately remove particulate matter and contaminating microbiology from the seawater.

A physical and chemical pre-treatment as used in today's conventional seawater desalination plants, do not guarantee the necessary quality of this water that is brought into contact with the reverse osmosis membranes, The problem of frequent membrane flushing, in addition to the problem of contamination of the marine aqueous environment, is therefore a problem, because of the discharge of the residual brine with a high content of the residual chemicals still contained in it.

For example, the dosing of NaClO, in order to eliminate microbiological contamination of seawater, is only effective in eliminating pathogenic micro-organisms, while other micro-organisms (viruses, bacteria, pyrogens, etc.), are only left in a state of dormancy (temporary inactivity, due to the presence of the biocide), which later when MBS (NaHSO₃) is dosed to remove the residual NaClO, and thus prevent it from coming into contact with the active layer (usually polyamide) and damaging it by chemical oxidation, the dormant bacteria are reactivated and are also found with abundant food (microorganisms killed by NaClO), They reproduce extremely rapidly, causing very serious fouling problems through the formation of abundant biological mass (biofouling) on the active layer of the membranes.

Also, when it comes to removing the presence of dispersed and suspended particles (colloidal), by dosing FeCl₃ (coagulant) and other coagulation aids (polyelectrolytes), in the different filtration units, the total removal of dispersed particles (of sizes >100 μm), in particular colloidal particles (of sizes between 1 and 100 μm), is not achieved, This also contributes to membrane fouling due to deposits of these particles on the active layer of the membrane (fouling).

Regarding the dosage of Hexa Meta Sodium Phosphate (HMFS), as an antifouling agent to control salt precipitation (scaling), due to the concentration polarisation process on the active layer of the membranes at the time when reverse osmosis is taking place, precipitation of a series of salts (CaCO₃, CaSO₄, BaSO₄, SrSO₄, CaF₂, non-colloidal reactive SiO₂), and to a lesser extent oxides or hydroxides of a microcrystalline nature (Fe, Mn, and Al), which are generally controlled in conventional reverse osmosis seawater desalination processes by dosing HMFS (Na₆P₆O₁₈).

New in this application is a major modification to the pre-treatment section of existing conventional seawater desalination plants, and basically the different physical treatment units (sand filters with porosity of 20 μm, medium porosity filters of 10 μm, and small porosity filters or cartridge filters of 1 to 5 μm) are replaced, by Ultra Filtration membranes of the so-called MBR type. This innovative solution has been experimentally tested in a seawater desalination plant.

### DESCRIPTION OF THE INVENTION

In order to achieve the above-mentioned design objectives, the invention consists of a new procedure for the pre-treatment of existing conventional seawater desalination plants.

In order to explain the differences and novelties of the invention, the basic stages of a conventional desalination plant are described first:
First, the raw seawater is taken from a submerged collection chamber consisting of a special concrete enclosure structure, with a water inlet through a very fine special steel grating to prevent the entry of fish, plants and other medium and coarse materials; and a set of pumps, which draw in the seawater needed to meet the desalination plant's processing flow, taking into account that these pumps will drive more than double the permeate production capacity, If, for example, the plant is to produce 6,000 m³/day of drinking water, the pumps in the collection system will have to pump 13,333 m³/day, of which 7,333 m³/day will be discharged into the sea in the form of waste, called “brine”.
An H₂SO₄ dosing system, consisting of a large storage tank with capacity for 1 month of supply, as well as dosing equipment fitted with automatic control instrumentation.
A NaClO dosing system, consisting of a large storage tank with a capacity of 1 month's supply, as well as dosing equipment fitted with automatic control instrumentation.
A FeCl₃ dosing system, consisting of a large storage tank with a capacity of 1 month's supply, as well as dosing equipment fitted with automatic control instrumentation.
These three dosages are carried out in the impulsion pipes that lead the seawater from the collection chamber to the coarse filtration system.
The “coarse filtration system” consists of a homogenization tank, a stilling chamber where the seawater will slow down the flow velocity, and then discharged into various coarse filtration units, usually sand filters, in which dispersed particles and flocculated colloidal particles will be removed, and then discharged into a large filtered water storage tank.
From the filtered water tank the seawater will be pumped by a set of pumps to the medium filtration units or plug filters.
The water is then dosed with Sodium Meta Bisulphite (NaHSO₃) from a dosing system consisting of a large storage tank with a capacity of 1 month's supply, as well as dosing equipment fitted with automatic control instrumentation.
From there they will pass through the fine filtration or pre-layer filtration units.
You will then receive a dosage of Hexa sodium metaphosphate (Na₆P6O₁₈), from a dosing system, consisting of a large storage tank with a capacity of 1 month's supply, as well as dosing equipment fitted with automatic control instrumentation.
After passing through the physical and chemical pre-treatments described above, the water is fed to the “high pressure and energy recovery system”, consisting of high-pressure pumps, which will raise the seawater pressure to the pressure necessary for the reverse osmosis process to take place (60 to 70 atmospheres of pressure); as well as by “energy recuperators” (Pelton turbines, Francis, ERI, etc.), which will transfer the pressure energy from the brine to a part of the feed water entering at low pressure (around 3 atmospheres of pressure).
The seawater, at working pressure, is fed to the reverse osmosis membrane system or “racks” where the reverse osmosis process is carried out.
From the “Membrane Racks”, on the one hand the waste seawater with a high concentration of salts (brine) is discharged to the “Brine Discharge System”, and another part of the seawater that permeates through the reverse osmosis membranes, called “permeate” or freshwater, is pumped to the post-treatment system, where the alkaline salts (Ca(OH)₂, CO₂) are restored to meet the requirements of “drinking water”, which is then discharged into the “drinking water” reservoirs.
Finally, through a pump system, the drinking water is pumped through the distribution lines to the public supply.
It should also be noted that, in the physical pre-treatment section, it is necessary to have a “sand filter washing system”, also a “spark plug filter cleaning system”, and a “precoat or cartridge filter cleaning system”, and finally there is also a need for a “filter wash water collection and disposal system”.

The present invention replaces the various physical treatment units (sand filters with a porosity of 20 μm, medium porosity filters with a porosity of 10 μm and fine porosity filters or cartridge filters with a porosity of 1 to 5 μm), by a single physical treatment unit using ultra-filtration membranes (MBR type) which eliminates the dosage of H₂SO₄, coagulants (FeCl₃, Al₂(SO₄)₃, AlCl₃, etc.), NaClO or any other biocide to remove micro-organisms in seawater and MBS (NaHSO₃) to remove residual NaClO. The dosing of HMFS as an antiscalant is replaced by the regulation of the pH (6-6.5) of the seawater, which will be fed to the reverse osmosis membrane rack.

To achieve the design objectives, the ultrafiltration membranes to be used are of the so-called MBR type and consist of hollow fiber membranes (with a porosity of 0.03 μm). The “outside-inside” operation, which operates by gentle suction of between 0.1 and 0.5 bar maximum, is structured in submersible cartridges, of the type generally used in domestic and industrial wastewater treatment, as opposed to UF membranes in “Spiral” configuration, that have been installed in the latest conventional desalination plants built in recent years.

These membranes in MBR configuration can retain dispersed particles (sizes >100 μm) as well as colloidal particles (sizes between 1 and 100 μm). This makes the dosing of coagulants (FeCl₃, Al₂(SO₄)₃, AlCl₃, etc.) unnecessary. These ultrafiltration membranes are also capable of retaining micro-organisms present in seawater, such as bacteria (0.5 and 800 μm), viruses (0.01 and 0.1 μm) and even pyrogens (0.002 and 0.015 μm). Therefore, neither the dosing of NaClO, nor any other biocides to kill micro-organisms in seawater is unnecessary. Therefore, if the dosing of biocide is not necessary, the dosing of MBS (NaHSO₃), which is intended to remove the residual NaClO, which, if it comes into contact with the reverse osmosis membranes, is not necessary either, with an active polyamide layer would damage it by chemical oxidation, nor is the dosing of H₂SO₄ necessary to enhance the action of the biocide and the coagulant, that both, in the novelty presented here, will not be dosed.

As for the control of membrane fouling because of concentration polarization, which causes the precipitation of different salts (CaCO₃, CaSO₄, BaSO₄, SrSO₄, CaF₂). Silica (SiO₂, reactive non-colloidal) from the different cations and anions present in seawater, which cause the so-called scaling fouling, the “autopsy” of membranes carried out in research work has been considered. These “autopsies” have shown that approximately 50% of the fouling materials are inorganic substances, The presence of silica, such as silica (SiO₂), is of the order of 30%, the second largest being calcium carbonates, in the order of 6.4%, the rest of the salts are in negligible quantities. It is therefore possible to eliminate the dosing of antifouling agents such as sodium hexa meta phosphate (Na₆P6O₁₈), basically replacing it by a pH regulation of the seawater with H₂SO₄ in a pH range between 6 and 6.5, determined by the Langelier equation (1930), using the mathematical expression (pHs=log (Ks/K2)−log Ca⁺⁺−log HCO₃), where Ks and K2 are equilibrium constants that depend on the temperature and ionic strength of the water, and which allow the calculation of the saturation pH (pHs) of seawater, at which CaCO₃ has no tendency to precipitate or dissolve; This pH value was experimentally determined and confirmed in a real process, the value of which is between 6 and 6.5, thus ensuring that no carbonate precipitation will occur during the reverse osmosis process in this pH range, or other salts, because the other salts have a higher saturation constant than carbonate, so that no chemical antifouling will be necessary.

This is the experimental justification, confirmed in a real seawater desalination plant, for the novelty presented in this patent application.

The advantages of this new pre-treatment are as follows:
Obtaining a chemically uncontaminated brine for use in the simple production of table salt for human consumption, and other industrial products (HCl, NaOH, etc.).
With the elimination of chemical dosing, operating costs are significantly reduced, thereby reducing the cost per m3 of drinking water produced.
By eliminating a number of chemical and physical treatment equipment, the investment costs are significantly reduced.
With the elimination of chemical dosing, producing a brine free of residual chemical contaminants, se reduce de manera importante la contaminación de las aguas del mar, por lo cual es un importante aporte a la protección y preservación de nuestro medio ambiente marino.

### BRIEF DESCRIPTION OF THE DRAWINGS

To complement the description being made and to assist in a better understanding of the features of the invention, a set of drawings is attached hereto as an integral part of this description, in which the following is shown for illustrative and non-limiting purposes:

FIG. 1.—Represents a block diagram of a seawater desalination plant by reverse osmosis, of the “conventional” type, in which we can see every one of the stages, highlighting the physical and chemical pre-treatment section, which is the subject of modification in this patent application.

FIG. 2.—Represents a block diagram of the object of the invention, where the conventional physical and chemical pre-treatment units are replaced by a unit provided with a tank fitted with ultrafiltration membrane cartridges, submerged hollow fibres (MBR type), through which a suction is exerted from the outside inwards, working at a pressure between 0.1 and 0.5 bar maximum.

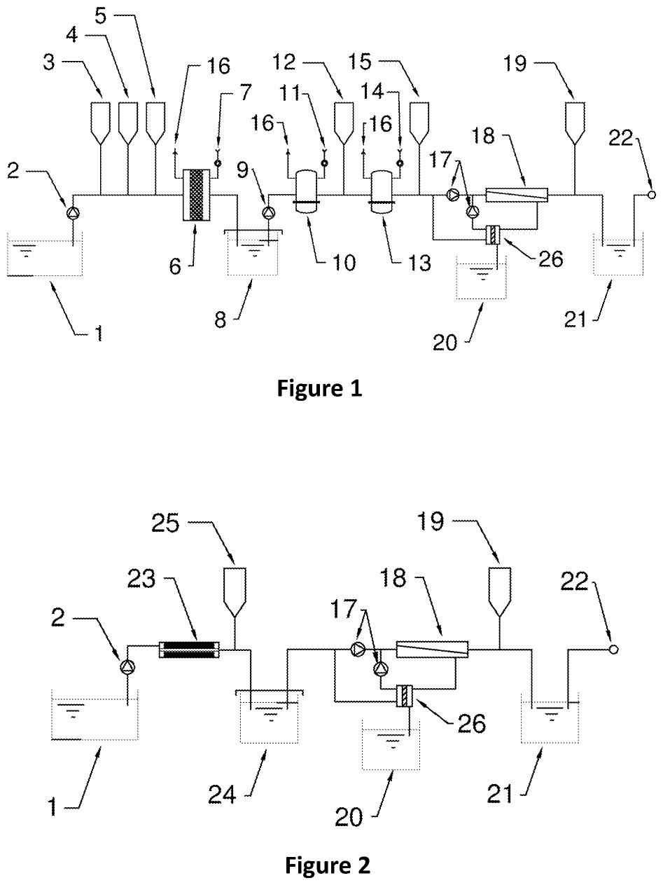

The following is a list of the different elements that make up a reverse osmosis seawater desalination plant, represented in the figures that make up the invention:
1=Raw seawater intake chamber.
2=Raw seawater pumping.
3=H₂SO₄ dosing system as an action enhancer for both the biocide and the coagulant.
4=Biocide (NaClO) dosage system.
5=dosing system for coagulant (FeCl₃) and flocculation aid.
6=Filtration system using sand filters.
7=Sand filter washing system.
8=Storage tank for filtered water after sand filters.
9=Pumping filtered water deposited in the storage tank.
10=Medium filtration units or spark plug filters.
11=Spark plug filter washing system.
12=NaHSO₃ (Sodium Meta Bisulphite—MBS) dosing system to neutralize the residual chlorine of NaClO.
13=Fine filtration units or pre-layer filtration.
14=Pre-layer or cartridge filter cleaning system.
15=Antifouling dosing system (sodium Hexa metaphosphate, Na₆P₆O₁₈)
16=Filter wash water collection and discharge system.
17=High-pressure system and energy recovery.
18=Reverse osmosis membrane system or “racks”.
19=“Post Treatment” system, with dosing of alkaline salts (Ca(OH)₂, CO₂) into the permeate water, by restoring the salts lost during reverse osmosis, and reach drinking water quality.
20=Brine discharge system.
21=“Drinking water” tanks.
22=Pump system for pumping drinking water to the public supply distribution lines.
23=Ultrafiltration membrane system (Type MBR).
24=Filtered water tank after ultrafiltration.
25=H₂SO₄ dosing system to regulate the pH of the seawater (6-6.5) to avoid salt precipitation in the reverse osmosis membranes.
26=Energy recuperators to transfer the pressure energy from the brine to a part of the feed water entering at atmospheric pressure.

### PREFERRED EMBODIMENT OF THE INVENTION

The invention consists of a new process for the pre-treatment of conventional reverse osmosis seawater desalination plants, characterized by replacing the different physical treatment units, such as the sand filters (6) and their washing system (7) with a porosity of 20 μm, plug filters (10) of medium porosity of 10 μm, and their backwashing system (11), and small porosity filters or cartridge filters (13) of 1 to 5 μm, and their backwashing system (14); by a single physical treatment unit using ultra-filtration membranes (23) of the MBR type. The H₂SO₄ dosing system (3), whose function was to enhance the action of both the biocide and the coagulant, was also eliminated, the NaClO or other biocide dosing system (4) designed to kill micro-organisms in seawater, the dosing system of any coagulants or flocculation aids (5) (FeCl₃, Al₂(SO₄)₃, AlCl₃, etc.), the MBS dosing system (12) designed to remove residual chlorine from NaClO. As well as the dosage of any chemical antifouling (15), replaced by regulating the pH (25) between 6 and 6.5 of the seawater.

Specifically, the physical treatment units and dosages to be removed are as follows:
H₂SO₄ dosing system (3) as a booster of the action of both the biocide (4) and the coagulant (5), consisting of a large storage tank with a capacity of 1 month's supply, as well as dosing equipment fitted with automatic control instrumentation.
Biocide dosing system, such as sodium hypochlorite NaClO (4), consisting of a large storage tank with a capacity of 1 month's supply, as well as dosing equipment fitted with automatic control instrumentation.
Dosing system for coagulant or flocculation aid (5), consisting of a large storage tank with a capacity of 1 month's supply, as well as dosing equipment fitted with automatic control instrumentation.
Sand filter filtration system (6), consisting of a homogenization tank, a stilling chamber where the seawater will slow down the flow rate, and then discharged into various coarse filtration units, usually sand filters, in which dispersed particles and flocculated colloids will be removed and then discharged into a large, filtered water storage tank (8).
Medium filtration units or spark plug filters (10).
Dosing system for the neutralizer of the biocidal product NaClO, by means of NaHSO₃ (MBS) (12) consisting of a large storage tank with a capacity of 1 month's supply, as well as dosing equipment fitted with automatic control instrumentation.
Fine filtration or precoat filtration units (13).
Dosing system for antiscalant such as sodium hexa meta phosphate (Na₆P₆O₁₈) (15), consisting of a large storage tank with a capacity of 1 month's supply, as well as dosing equipment fitted with automatic control instrumentation.
Sand filter washing system (7).
Spark plug filter cleaning system (11).
Precoat or cartridge filter cleaning system (14).
Filter wash water collection and discharge system (16).

This patent application eliminates both physical and chemical pre-treatment, by incorporating an ultrafiltration system (23) consisting of submerged ultrafiltration membranes (MBR type), in hollow fiber configuration operating by suction from the outside to inside, operating at a vacuum pressure between 0.1 and 0.5 bar maximum.

These ultrafiltration membranes can retain the micro-organisms present in seawater, such as bacteria (0.5 and 800 μm), viruses (0.01 and 0.1 μm), including pyrogens (0.002 and 0.015 μm).

In this way, a seawater desalination plant, using “Reverse Osmosis” technology, structured with this innovation, is more compact and consists of the following stages:
The submerged raw seawater collection system (1), consisting of a special concrete structure, the water inlet is made of a very fine special steel grating, to prevent the entry of fish, plants, and other medium and coarse materials.
A set of seawater collection pumps (2) required to meet the processing flow rate of the desalination plant, considering that these pumps will drive more than double the permeate production capacity.
An ultrafiltration system (23) comprising a tank in which are immersed a set of ultrafiltration membrane cartridges, in hollow fiber configuration (with porosity of 0.03 μm), of the MBR type, which perform suction from the outside to inside, by applying vacuum pressure, between 0.1 and 0.5 bar maximum, in which dispersed particles (of sizes >100 μm) are retained, as well as colloidal particles (sizes between 1 and 100 μm). These ultrafiltration membranes are of the type generally used in domestic and industrial wastewater treatment, unlike ultrafiltration membranes in spiral configuration, that have been installed in the desalination plants built in recent years.
The water that has been ultra-filtered in the ultra-filtration system (23) is discharged into a large, filtered water tank (24).
A H₂SO₄ dosing system to regulate the pH of seawater (25) to prevent salt precipitation in reverse osmosis membranes.
Subsequently, the ultra-filtered and pH-regulated water is captured by the pumps of the high-pressure and energy recovery system (17), consisting of high-pressure pumps, which will raise the seawater pressure to the pressure necessary for the reverse osmosis process to take place (60 to 70 atmospheres of pressure); as well as by “energy recuperators” (Pelton Turbines, Francis, ERI, etc.) (26), which will transfer the pressure energy from the brine to a part of the feed water entering at atmospheric pressure.
The seawater, at working pressure, is fed to the Reverse Osmosis membrane system or “Racks” (18) where the reverse osmosis process is carried out.
By the one side, the reverse osmosis process produces waste seawater with a high concentration of salts (brine) and sends it to the brine discharge system (20).
By the other side, after reverse osmosis, the ‘permeate’ or fresh water is obtained, which is pumped to the post-treatment system (19), where the alkaline salts (Ca (OH)₂, CO₂) that were lost during reverse osmosis are restored, to meet the requirements of water fit for human consumption, which is subsequently discharged into the “drinking water” reservoirs (21).
Finally, through a pump system, the drinking water is pumped to the distribution lines of the public water supply (22).

This process also produces a chemically uncontaminated brine (20) for use in the simple production of table salt for human consumption and other industrial products (HCl, NaOH, etc.).

1. Procedure for the elimination of the use of chemical products in the pre-treatment of seawater desalination plants by reverse osmosis, characterized by the replacement of physical treatment units consisting of sand filters with porosity of 20 μm (6), medium porosity filters of 10 μm (10) and small porosity filters of 1 to 5 μm (13), as well as the washing systems for sand filters (7), medium porosity filters (11) and small porosity filters (14), by a single physical treatment unit, consisting of a system of ultrafiltration membranes of the type known as MBR (23), as well as by eliminating the dosing of chemical antiscalant such as Na₆P₆O₁₈ (15) by dosing H₂SO₄ (25) to regulate the pH of seawater to between 6 and 6.5 to prevent salt precipitation in reverse osmosis membranes (18).

2. Procedure for the elimination of the use of chemical products in the pre-treatment of seawater desalination plants by reverse osmosis according to claim 1, characterized by eliminating the dosage of H₂SO₄ (3) as a booster of the action of the biocide (4) and the coagulant (5), the elimination of the dosage of NaClO as a biocide (4), the elimination of the dosage of FeCl₃ as a coagulant or flocculation aid (5), as well as the elimination of the dosage of sodium metabisulphite (NaHSO₃) as a neutralizer of the residual sodium hypochlorite (12).
